(19) United States
(12) Patent Application Publication
(10) Pub. No.: US 2018/0174184 A1
(43) Pub. Date: Jun. 21, 2018

(54) DECISION DEVICE, DECISION METHOD, AND NON-TRANSITORY COMPUTER READABLE STORAGE MEDIUM

(71) Applicant: YAHOO JAPAN CORPORATION, Tokyo (JP)

(72) Inventors: Hiroki NARUKAWA, Tokyo (JP); Masayuki YANO, Tokyo (JP); Naoki ISHIKAWA, Tokyo (JP)

(73) Assignee: YAHOO JAPAN CORPORATION, Tokyo (JP)

(21) Appl. No.: 15/694,208

(22) Filed: Sep. 1, 2017

(30) Foreign Application Priority Data
Dec. 16, 2016 (JP) 2016-244594

(51) Int. Cl. G06Q 30/02; G06F 17/30

(52) U.S. Cl. CPC G06Q 30/0251; G06F 17/30979

(57) ABSTRACT

According to one aspect of an embodiment a decision device refers to condition information, in which a plurality of conditions that indicates an attribute of a distribution destination of predetermined information and that includes a condition in which an allowable range is set is represented by a Boolean operation expression, and that determines whether the attribute information matches the plurality of the conditions. The decision device determines, when it is determined that, from among the plurality of the conditions, the attribute information matches the condition in which the allowable range is set, whether the attribute information satisfies the allowable range that is set in the condition. The decision device decides, based on determination results obtained by the first determination unit and the second determination unit, whether the predetermined information is a distribution target.

### CROSS-REFERENCE TO RELATED APPLICATIONS

The present application claims priority to and incorporates by reference the entire contents of Japanese Patent Application No. 2016-244594 filed in Japan on Dec. 16, 2016.

### BACKGROUND OF THE INVENTION

### 1. Field of the Invention

The present invention relates to a decision device, decision method, and a computer-readable recording medium.

### 2. Description of the Related Art

In recent years, with the rapid spread of the Internet, information distribution based on information acquired via a network has been actively performed. For example, targeting distribution in which an attribute of a user corresponding to the distribution destination of the information is previously registered as distribution destination information and information associated with the attribute of the user corresponding to the distribution destination is selectively distributed is performed. As this type of information distribution, there is a known technology that searches for information associated with the attribute of the user corresponding to the distribution destination by attaching a Boolean (logical value) condition to the information itself that becomes the distribution target.

Patent Document 1: Japanese Laid-open Patent Publication No. 2016-153972.

Non-Patent Document 1: Steven Euijong Whang, Hector GarciaMolina, Chad Brower, Jayavel Shanmugasundaram, Sergei Vassilvitskii, Erik Vee, “Indexing Boolean Expressions” [online], [searched on Nov. 30, 2016], Internet (http://theory.stanford.edu/˜sergei/papers/vldb09-indexing.pdf).

However, in the conventional technology described above, there may be a case in which information that becomes the distribution target is not always promptly extracted.

For example, there may be a request to distribute information in accordance with the date and time or the frequency of a certain search query searched by a user. However, to realize such a request, in the conventional technology, the distribution destination information is set for each combination of the date and time or the frequency that can be set with the attribute of a user corresponding to the distribution destination of the information. Consequently, the number of pieces of the distribution destination information to be compared with a query is increased. This can possibly result in an inability to promptly extract the information that becomes the distribution target.

### SUMMARY OF THE INVENTION

It is an object of the present invention to at least partially solve the problems in the conventional technology.

According to one aspect of an embodiment a decision device includes a first determination unit that refers to, when a query that includes attribute information indicating an attribute of a distribution destination is received, condition information, in which a plurality of conditions that indicates an attribute of a distribution destination of predetermined information and that includes a condition in which an allowable range is set is represented by a Boolean operation expression, and that determines whether the attribute information matches the plurality of the conditions. The decision device includes a second determination unit that determines, when it is determined that, from among the plurality of the conditions, the attribute information matches the condition in which the allowable range is set, whether the attribute information satisfies the allowable range that is set in the condition. The decision device includes a decision unit that decides, based on determination results obtained by the first determination unit and the second determination unit, whether the predetermined information is a distribution target.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a decision process performed by an information distribution device according to an embodiment;

FIG. 2 is a diagram illustrating a configuration example of the information distribution device according to the embodiment;

FIG. 3 is a diagram illustrating an example of information registered in an advertisement database according to the embodiment;

FIG. 4 is a diagram illustrating an example of information registered in an index database according to the embodiment;

FIG. 5 is a flowchart illustrating an example of the flow of the decision process performed by the information distribution device according to the embodiment; and

FIG. 6 is a diagram illustrating an example of a hardware configuration.

### DETAILED DESCRIPTION OF THE PREFERRED EMBODIMENTS

Hereinafter, modes (hereinafter, referred to as “embodiments”) for carrying out a decision device, a decision method, and a non-transitory computer readable storage medium according to the present invention will be described in detail with reference to drawings. The decision device, the decision method, and the non-transitory computer readable storage medium according to the present invention are not limited to the embodiments. Furthermore, in the embodiments described below, the same components are denoted the same reference numerals and an overlapping explanation will be omitted.

### Embodiment

1. Example of an Information Distribution Device

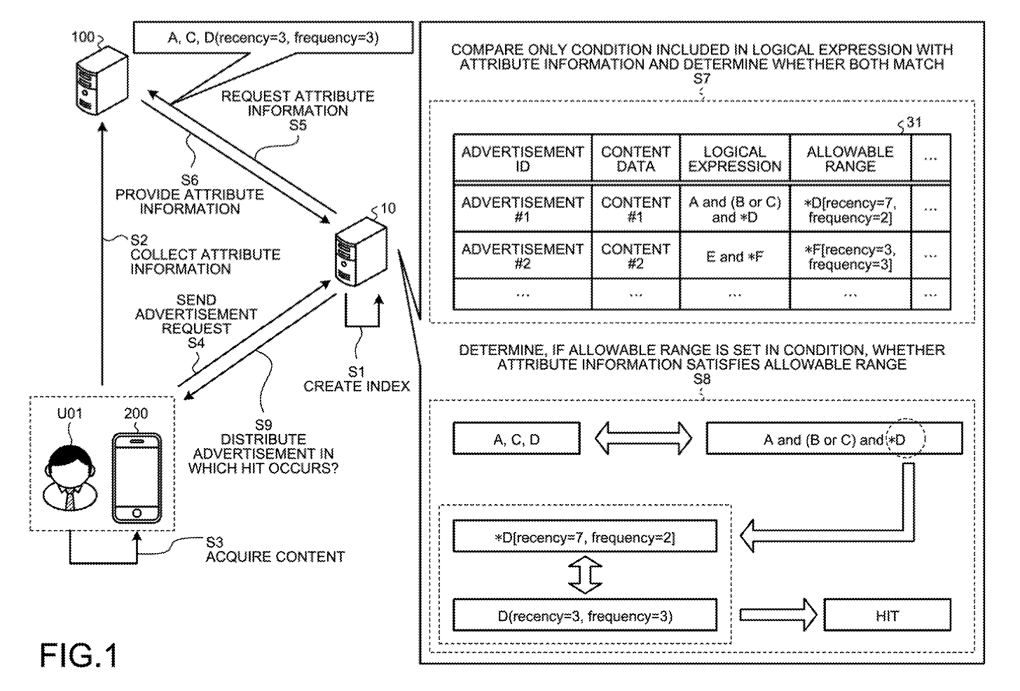

First, an example of a decision process performed by an information distribution device corresponding to an example of the decision device will be described with reference to FIG. 1. FIG. 1 is a diagram illustrating an example of a decision process performed by the information distribution device according to an embodiment.

Furthermore, in a description below, an example in which an information distribution device 10 distributes content related to an advertisement to a user terminal 200 used by a user U01; however, the embodiment is not limited to this. Namely, the information distribution device 10 may also distribute arbitrary content to the user U01 as long as the information distribution device 10 distributes content that is in accordance with various kinds of attributes of the user U01, such as demographic attributes or psychographic at of the user U01, an action history of the user U01, or the like.

Furthermore, it is assumed that the content related to an advertisement is not only a profit-oriented or nonprofit advertisement but also recruitment of volunteers, a public service advertisement, a public notification, or another arbitrary piece of content. Namely, in addition to the content including the information related to a so-called advertisement, content may also include an image, a moving image, characters, a diagram, a symbol, a hyperlink, or another arbitrary piece of content together with a text as long as the content is interested by a user and the content widely notifies of information included in the content or information included in content (for example, a landing page, etc.) associated with the content. Furthermore, if the content is content related to an advertisement, an information processing apparatus (for example, a distribution source server 300) that registers the advertisement may also be in addition to an information processing apparatus used by a so-called advertiser, an information processing apparatus used by an advertising agency that creates or registers an advertisement requested by an advertiser.

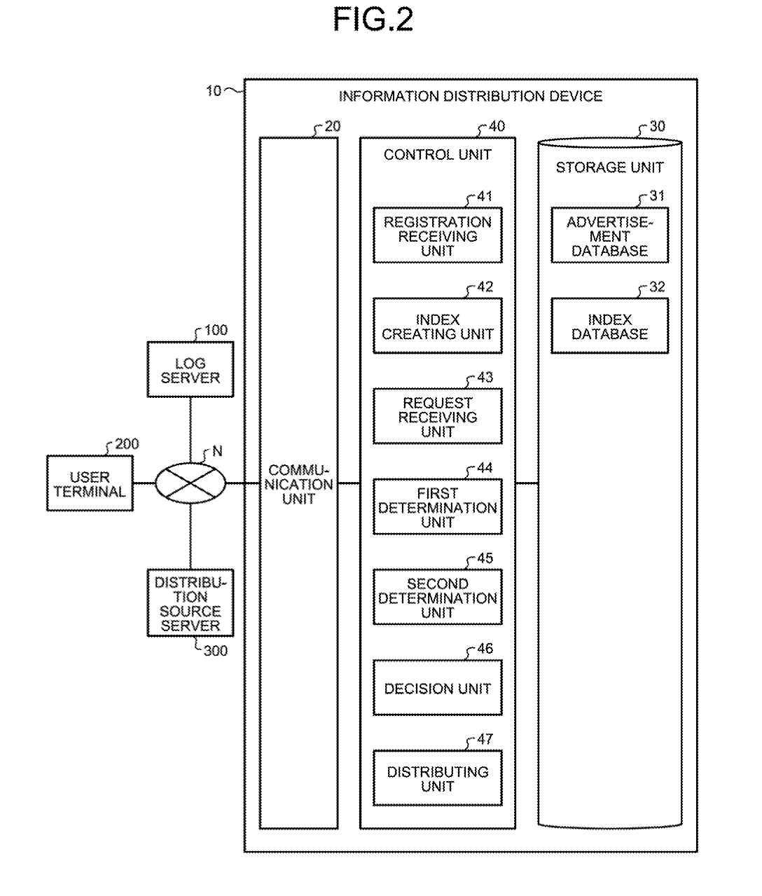

The information distribution device 10 is an information processing apparatus that can communicate with, via a predetermined network N, such as the Internet, or the like, a log server 100, the user terminal 200, and the distribution source server 300 (for example, see FIG. 2) used by the distribution source that requests to distribute an advertisement and is implemented by, for example, a server device, a cloud system, or the like. Furthermore, the information distribution device 10 may also communicate with, via the network N, an arbitrary number of the log servers 100, the user terminals 200, and the distribution source servers 300.

The log server 100 collects various kinds of logs related to the user U01. For example, the log server 100 collects, as attribute information on the user U01, arbitrary information related to the user U01, such as a demographic attribute including the gender, an age group, the address, or the like, of the user U01; a psychographic attribute including hobbies, taste, or the like of the user U01; the current location of the user U01; a browsing history of web content; a purchase history of the object purchased via electronic commerce; a history of a search query; or the like. Furthermore, the attribute information on the user U01 is acquired by using a technology of, for example, Bcookie, or the like.

The user terminal 200 is a smart device, such as a smartphone, a tablet terminal, or the like, and is a mobile terminal device that, can communicate with an arbitrary server device via a wireless communication network, such as third Generation (3G), Long Term Evolution (LTE), or the like. Furthermore, the user terminal 200 may also be, in addition to a smartphone, an information processing apparatus, such as a desktop personal computer (PC), a notebook PC, or the like.

The distribution source server 300 is an information processing apparatus used by the distribution source of an advertisement and is implemented by a server device, a PC, or the like. For example, when the distribution source server 300 registers an advertisement that becomes the distribution target in the information distribution device 10, the distribution source server 300 registers condition information indicating a condition of a user corresponding to the distribution destination of the advertisement. More specifically, the distribution source server 300 specifies the attribute of the user corresponding to the distribution destination by using a Boolean operation expression (hereinafter, referred to as a “logical expression”). For example, if the distribution source server 300 wants to distribute an advertisement #1 to the user having the attribute of a “male” in his “thirties” interested in plastic models, the distribution source server 300 registers, as the condition information on the advertisement #1, the logical expression of “thirties and male and plastic models” constituted by the condition of “thirties”, “male”, and “plastic models”.

In such a case, if the distribution source server 300 receives a distribution request for the advertisement from the user terminal 200, the distribution source server 300 acquires the attribute information on the user U01 from the log server 100. Then, the distribution source server 300 determines whether the acquired attribute information satisfies the logical expression of “thirties and male and plastic models” and distributes, if the attribute information satisfies the logical expression, the advertisement #1 to the user terminal 200. Namely, the information distribution device 10 performs a targeting search of the content by using the Boolean operation expression.

In a description below, each of the attributes included in the condition information that is previously set to the advertisement that becomes the distribution target, i.e., the attribute of each of the elements of the logical expression, is correctively referred to as a “condition”.

2. About Distribution of an Advertisement

In the following, an example of a process in which the information distribution device 10 distributes an advertisement will be described. For example, there may be a case in which, if a logical conjunction is satisfied, the information distribution device 10 stores therein a plurality of combinations of conditions of an advertisement that becomes the distribution target, i.e., a plurality of combinations of conditions constituting the logical conjunction (hereinafter, collectively referred to as “combinations of logical conjunctions). For example, if a logical conjunction is satisfied, such as “(A and B) or (C and D) or (B)”, the information distribution device 10 stores therein a combination of the conditions “A” and “B”, a combination of the conditions “C” and “D”, and a condition “E” that are condition of the advertisement becomes the distribution target. In such a case, if the combination of the attributes “A” and “B”, the combination of the attributes “C” and “D”, or the combination of the attribute “F” is included in the attribute information, the information distribution device 10 selects the associated advertisement as the distribution target.

Furthermore, a known technology can be used for a method of, performed by the information distribution device 10, searching for an advertisement in which the attribute information satisfies the condition. In the following, a description will be given of an example of a process of selecting, by performing a logical operation using an interval algorithm, an advertisement associated with the condition information fit for the attribute condition of the user corresponding to the distribution destination; however, the embodiment is not limited to this.

At this point, there may be a request to set a condition in accordance with the date and time or the frequency as the condition of the distribution destination the advertisement. For example, there may be a request to distribute an advertisement to a user who has input a predetermined search query in a certain period of time by a predetermined number of times. However, when implementing such a request, in the conventional technology, the condition information in which an allowable range is set is developed for each combination of the date and time or the frequency that can be set with the attribute of the user corresponding to the distribution destination of the information. Consequently, the number of pieces of the condition information to be compared with the attribute information is increased. This can possibly result in an inability to promptly extract the information that becomes the distribution target.

2-1. About a Decision Process

Accordingly, the information distribution device 10 performs the following decision process. For example, if the information distribution device 10 receives a query including the attribute information that indicates the attribute of the distribution destination, the information distribution device 10 refers to the condition information in which a plurality of conditions that indicates the attribute of the distribution destination of predetermined information and that includes a condition in which an allowable range is set is represented by the Boolean operation expression. Furthermore, the information distribution device 10 determines whether the attribute information matches the plurality of the conditions. Then, if the information distribution device 10 determines that the attribute information matches the condition, from among the plurality of the conditions, in which the allowable range is set, the information distribution device 10 determines whether the attribute information satisfies the allowable range that is set in the condition. Furthermore, the information distribution device 10 decides, based on each of the determination results, whether predetermined information is the distribution target.

Namely, the information distribution device 10 determines whether the attribute information matches the condition without regard for the allowable range and determines, only when it is determined that, the attribute information matches the condition in which the allowable range is set, whether the subject attribute information satisfies the allowable range that is set in the condition. For example, if data indicating that a predetermined search query is input “two times” or more within “7 days” is set as the condition of the advertisement, the information distribution device 10 only determines, in advance based on the attribute information, whether the user has input the predetermined search query regardless of the period of time or the frequency. Then, only when the information distribution device 10 determines that the user has input the predetermined search query, the information distribution device 10 determines the period of time or the frequency of the predetermined search query that was input by the user.

in the following, an example of the decision process will be described. For example, the information distribution device 10 receives, as the condition information indicating the distribution destination of the advertisement, the logical expression to which the information indicating that the allowable range has been set is attached and the allowable range information indicating the allowable range. For example, the information indicating that the allowable range has been set is represented by “*” in a logical expression, in such a case, the information distribution device 10 receives the condition information, such as the logical expression “A and (B or C) and *D”, and also receives the allowable range information “recency=7, frequency=2”.

At this point, the logical expression “A and. (B or C) and *D” indicates the condition that an advertisement be the distribution target when the attribute information on the distribution destination includes the attribute “A” and also includes the attribute “B” or the attribute “C” and when the attribute “D” is within a predetermined allowable range. Furthermore, the allowable range information “recency=7, frequency=2” indicates that the distribution destination satisfies the condition associated with the allowable range information “2” or more times within “7” days. For example, if the attribute “D” indicates that search query of “doughnut” has been input, both the logical expression and the allowable range information described above indicate that the condition in which the distribution destination has searched the search query of “doughnut” “2” or more times within “7” days. In this way, the information distribution device 10 separately receives the registration of the condition information and the allowable range information that indicates the allowable range that is set in the condition included in the condition information.

In contrast, the information distribution device 10 receives, as the attribute information, combination of the attribute of the distribution destination and the numerical value related to that attribute. For example, the information distribution device 10 receives, as the attribute information, the information, such as “A, C, D (recency=3, frequency=3)”. This attribute information indicates that the distribution destinations are the attribute “A”, the attribute “C”, and the attribute “D” and indicates that the attribute “D” is satisfied “3” or more times within “3” days.

Then, if the information distribution device 10 receives the attribute information as a query, the information distribution device 10 determines, by using the interval algorithm, whether each of the conditions included in a logical expression matches the attribute information. Namely, the information distribution device 10 determines, assuming that the allowable range information is not set, whether each of the conditions included in the logical expression matches the attribute information. Then, if the condition in which the allowable range is set matches the attribute information, the information distribution device 10 performs a subroutine that determines whether the attribute information satisfies the allowable range and then the information distribution device 10 determines whether the attribute information satisfies the allowable range. Then, the information distribution device 10 determines that the condition that satisfies the attribute information satisfies the logical expression and determines that the attribute information satisfies all of the allowable ranges that are set in the conditions that satisfy the logical expression from among the conditions, the information distribution device 10 decides that predetermined information is the distribution target.

For example, the information distribution device 10 determines whether the attributes “A”, “C”, and “D” included in the attribute information match the conditions “A”, “B”, “C”, and “D” included in the condition information. Furthermore, if the condition “D” in which the allowable range is set matches the attribute “D”, the information distribution device 10 determines whether the numerical value “recency=3, frequency=3” that are set in the attribute “D” satisfies the allowable range information “recency=7, frequency=2” that was set in the condition “D”.

For example, the information distribution device 10 determines whether the value of “recency” that was set in the attribute becomes equal to or less than the value of “recency” that was set in the condition and determines whether the value of “frequency” that was set in the attribute becomes equal to or greater than the value of “frequency” that was set in the condition. Then, if the value of “recency” that was set in the attribute becomes equal to or less than the value of “recency” that was set in the condition and the value of “frequency” that was set in the attribute becomes equal to or greater than the value of “frequency” that was set in the condition, the information distribution device 10 determines that the numerical value that is set in the attribute information satisfy the allowable range set in the condition.

Consequently, in the example described above, from among the conditions included in the logical expression “A and (B or C) and *D”, because the condition “A”, the condition “C”, and the condition “D” match the attribute information, the attribute information received as the query satisfies the logical expression. Furthermore, in the example described above, from among the conditions included in the logical expression “A and (B or C) and *D”, the attribute information satisfies all of the allowable ranges that are set in the condition “A”, the condition “C”, and the condition “D” corresponding to the factors that satisfy the logical expression, the allowable range set in the condition “D”. Consequently, the information distribution device 10 determines that the advertisement in which the logical expression described above is set as the condition information is the distribution target.

2-2. About a Plurality of Settings

Furthermore, the information distribution device 10 may also receive the condition information including a plurality of conditions in each of which the allowable range is set. For example, the information distribution device 10 may also receive the condition information, such as the logical expression “A and (B or *C) and *D”, the allowable range information associated with the condition “B”, and the allowable range information associated with the condition “D”.

In such a case, the information distribution device 10 determines whether the attribute included in the attribute information matches each of the condition “A”, the condition “B”, the condition “C”, and the condition “D” and determines, if the attribute “C” matched with the condition “C” is included in the attribute information, whether the numerical value that was set in the attribute “C” satisfies the allowable range information associated with the condition “C”. Furthermore, if the attribute “D” matched with the condition “D” is included in the attribute information, the information distribution device 10 determines whether the numerical value that is set in the attribute “D” satisfies the allowable range information associated with the condition “D”.

Furthermore, for example, if the condition “A”, the condition “C”, and the condition “D” match the attribute information, the information distribution device 10 determines whether the numerical value that was set in the attribute “C” satisfies the allowable range information associated with the condition “C” and determines whether the numerical value that was set in the attribute “D” satisfies the allowable range information associated with the condition “D”. Namely, the information distribution device 10 determines whether the attribute condition satisfies the allowable ranges that are set in the condition “C” and the condition “D” in each of which the allowable range is set from among the condition “A”, the condition “C”, and the condition “D” corresponding to the factors that satisfy the logical expression “A and (B or *C) and *D”. Then, if the numerical value that was set in the attribute “C” satisfies the allowable range information associated with the condition “C” and if the numerical value that was set in the attribute “D” satisfies the allowable range information associated with the condition “D”, the information distribution device 10 determines that the advertisement with respect to the condition information is the distribution target.

Furthermore, for example, if the condition “A”, the condition “B”, and the condition “C” match the attribute information, the information distribution device 10 determines whether the numerical value that was set in the attribute “D” satisfies the allowable range information associated with the condition “D”. Namely, from among the condition “A”, the condition “B”, and the condition “C” corresponding to the factors that satisfy the logical expression “A and (B or *C) and *D”, the information distribution device 10 determines whether the attribute condition satisfies the allowable range that is set in the condition “D” in which the allowable range has been set. Then, if the numerical value that was set in the attribute “D” satisfies the allowable range information associated with the condition “D”, the information distribution device 10 determines that the advertisement with respect to the condition information is the distribution target.

In this way, if the allowable range is set in the condition, the information distribution device 10 determines whether the condition matches the attribute information and determines, only when the condition matches the attribute information, whether the attribute information satisfies the allowable range. Then, the information distribution device 10 decides, based on the determination results, whether the advertisement is the distribution target. Consequently, if the allowable range is included, the information distribution device 10 can determine whether the condition information matches the attribute information without developing the condition information into a plurality of pieces of condition information that satisfies the allowable ranges, thereby promptly extracting the advertisement that becomes the distribution target.

For example, in the conventional technology, because the number of pieces of the developed condition information is exponentially increased every time the allowable range is set in the condition information, the latency of the comparison between the condition information and the attribute information is accordingly increased. However, regarding the information distribution device 10, even if the allowable range is set in the condition information, the latency of the comparison between the condition information and the attribute information becomes the latency of the comparison between one piece of attribute information and one piece of condition information and the latency that is used to determine whether the numerical value of the attribute information satisfies the set allowable range. Here, the latency for determining whether the numerical value of the attribute information satisfies the set allowable range is merely linearly increased (for example, integral multiple) with respect to the number of allowable ranges. Consequently, even if an allowable range is set in the condition information, the information distribution device 10 can suppress the latency of the comparison between the condition information and the attribute information.

2-3. About the Condition or the Attribute in Which an Allowable Range is Set

In the examples described above, a conceptual condition, such as the condition “D”, has been described as the condition in which the allowable range is set. Here, an arbitrary condition can be used for the condition in which the allowable range is set.

For example, the information distribution device 10 may also receive the setting of an arbitrary allowable range about an arbitrary condition, such as whether the age group of the distribution destination is within a predetermined allowable range, whether the location of the distribution destination is within a predetermined area, whether the distribution destination has taken a predetermined action in a predetermined period of time, whether the distribution destination has taken a predetermined action at a predetermined frequency, or the like. For example, if the information distribution device 10 receives both the condition indicating the action of the distribution destination and the allowable range information indicating the period of time or the frequency of the action, the information distribution device 10 only determines whether the distribution destination has taken the subject action (i.e., only determines whether the condition matches the attribute) and determines, only when it is determined that the action has been taken, whether the date and time or the frequency of the action is within the allowable range. Namely, the information distribution device 10 can separately set an arbitrary condition and an arbitrary allowable range as long as the information distribution device 10 separately compares the condition of distributing an advertisement and the allowable range that is set to the subject condition with the attribute information.

For e ample, if the information distribution device 10 receives, as the attribute information, a combination of action information indicating the action taken by the distribution destination and the date and time of the action, the frequency of the action, or the number of times the action was taken, the information distribution device 10 determines whether the action indicated by the action information included in the subject combination matches the action indicated by the condition. Then, if the information distribution device 10 determines that the action indicated by the action information matches the action indicated by the condition, the information distribution device 10 only determines whether the date and time, the frequency, or the number of times included in the subject combination satisfies the allowable range that is set in the condition. For example, the information distribution device 10 may also receive, in addition to the search query input by the distribution destination as the action information, the date and time in which the search query is input, the frequency of the search query, or the number of times of the search queries.

2-4. Example of a Decision Process

In the following, a specific example of the decision process performed by the information distribution device 10 will be described. Furthermore, in the example illustrated in FIG. 1, the pieces of the attribute information “A” to “E” and the conditions “A” to “E” are referred to as the “attribute A” to the “attribute E”. First, the information distribution device 10 receives the registration of the advertisement that becomes the distribution target, the condition information, and a coefficient. In such a case, the information distribution device 10 creates an index by using the interval algorithm (Step S1).

For example, the information distribution device 10 receives the data on the advertisement, the logical expression “A and (B or C) and *D”, and the allowable range information “*D[recency=7, frequency=2]” associated with the condition “D”. In such a case, the information distribution device 10 allocates the same range from among 1 to 4095 continuous values to a plurality of characteristics constituting the logical disjunction and allocates 1 to 4095 continuous values to one or more characteristics constituting the logical conjunction. For example, the information distribution device 10 allocates both the start value “1” and the final value “1” to the condition “A” as the continuous values and allocates both the start value “2” and the final value “2” to the condition “B” as the continuous values. Furthermore, the information distribution device 10 allocates both the start value “2” and the final value “2” to the condition “C” as the continuous values and allocates both the start value “3” and the final value “4095” to the condition “D” as the continuous values. Then, the information distribution device 10 creates an advertisement ID “advertisement #1” that is used to identify the received advertisement; creates the index including the advertisement ID, the start values, and the final values; and then stores the created index.

In contrast, the log server 100 collects the attribute information on the user U01 at a predetermined timing (Step S2). For example, the log server 100 collects, as the attribute information, the gender, the age group, and the living district of the user U01, a history of a search query, a matter of interest or concern, or the like. Furthermore, the log server 100 may also acquire the attribute information on the user U01 by collecting various kinds of logs related to an operation or browsing performed by the user U01 and by analyzing the collected logs.

At this time, it is assumed that the user terminal 200 has acquired, in accordance with the operation performed by the user U01, various kinds of web content from a web server (not illustrated) (Step S3). This web content a predetermined advertisement area is arranged and includes therein an instruction to acquire the advertisement that is arranged in the advertisement area and that is displayed on that area. Thus, the user terminal 200 sends an advertisement request to the information distribution device 10 (Step S4).

In such a case, the information distribution device 10 requests the log server 100 to send the attribute information on the user U01 (Step S5). Consequently, the log server 100 provides the attribute information on the user U01 to the information distribution device 10 (Step S6). For example, the log server 100 provides the attribute “A”, the attribute “C”, and the attribute “D (recency=3, frequency=3)” as the attribute information on the user U01. Then, the information distribution device 10 compares only the condition included in the logical expression with the attribute information and determines whether both match (Step S7). Namely, the information distribution device 10 determines, by using the interval algorithm without regard for the allowable range information, whether the attribute information satisfies the condition information.

For example, the information distribution device 10 determines, assuming that the attribute “A”, the attribute “C”, and the attribute “D” are the attribute information, whether the conditions included in the logical expression of the advertisement indicated by the advertisement ID (Identifier) “advertisement #1” and the advertisement it) “advertisement #2” match the attribute information of the query. Furthermore, if the conditions match the attribute information, the information distribution device 10 stores both the start value and the final value from among the continuous values associated with the subject condition in a predetermined determination matrix and then determines whether the value reaches a predetermined value.

For example, the information distribution device 10 determines, from among the conditions included in the logical expression “A and (B or C) and *D”, whether the condition “A”, the condition “C”, and the condition “D” match the attribute “A”, the attribute “C” and the attribute “D” in the attribute information, respectively. In such a case, the information distribution device 10 uses the determination matrix and determines whether the continuous values allocated to the condition “A”, the condition “C”, and the condition “C” continue from “1” to “4095”. Here, regarding the condition “A”, both the start value “1” and the final value “1” are allocated as the continuous values; regarding the condition “C”, both the start value “2” and the final value “2” are allocated as the continuous values; and, regarding the condition “D”, both the start value “3” and the final value “4095” are allocated as the continuous values. Consequently, the information distribution device 10 determines that the continuous values continues to “4095” and determines that the attribute information satisfies the logical expression of the advertisement ID “advertisement #1”.

In parallel with the process performed by using the interval algorithm, the information distribution device 10 determines whether the allowable range is set in the condition that is matched with the attribute information and determines, if the allowable range is set, whether the attribute information satisfies the allowable range (Step S8). For example, in the example illustrated in FIG. 1, the allowable range is set in the condition “D”. In such a case, the information distribution device 10 determines whether the numerical value “(recency=3, frequency=3)” that is set in the attribute “D” is the attribute information satisfies the allowable range information “*D [recency=7, frequency=2]”. More specifically, the information distribution device 10 determines whether the value of “recency” in the attribute information is equal to or less than the value of “recency” included in the allowable range information and the value of “frequency” in the attribute information is equal to or greater than the value of “frequency” included in the allowable range information. Then, if the value of “recency” in the attribute information is equal to or less than the value of “recency” included in the allowable range information and the value of “frequency” in the attribute information is equal to or greater than the value of “frequency” included in the allowable range information, the information distribution device 10 determines that the numerical value in the attribute information satisfies the allowable range information.

Furthermore, the information distribution device 10 decides the advertisement targeted for the distribution in accordance with the match result of the logical expression and the attribute information and in accordance with the comparison result between the allowable range information and the numerical value. For example, if the condition “A”, the condition “B”, and the condition “D” match the attribute information and if, from among the condition “A”, the condition “B”, and the condition “D” that are the factors in satisfying the logical expression, the attribute condition satisfies the allowable range that is set in the condition “D” in which the allowable range has been set, the information distribution device 10 determines that the advertisement of the advertisement ID “advertisement #1” is the distribution target. Then, the information distribution device 10 distributes, to the user terminal 200, the advertisement specified as the distribution target, i.e., the advertisement in which a hit occurs in the attribute information (Step S9).

3. Configuration of the Information Distribution Device

In the following, a description will be given of an example of the functional configuration of the information distribution device 10 described above. FIG. 2 is a diagram illustrating a configuration example of the information distribution device according to the embodiment. As illustrated in FIG. 2, the information distribution device 10 includes a communication unit 20, a storage unit 30, and a control unit 40.

The communication unit 20 is implemented by, for example, a network interface card (NIC), or the like. Then, the communication unit 20 is connected to a network N in a wired or a wireless manner and sends and receives information to and from the information distribution device 10 or the user terminal 200.

The storage unit 30 is implemented by, for example, a semiconductor memory device, such as a random access memory (RAM), a flash memory, or the like, or a storage device, such as a hard disk, an optical disk, or the like. Furthermore, the storage unit 30 stores therein an advertisement database 31 and an index database 32.

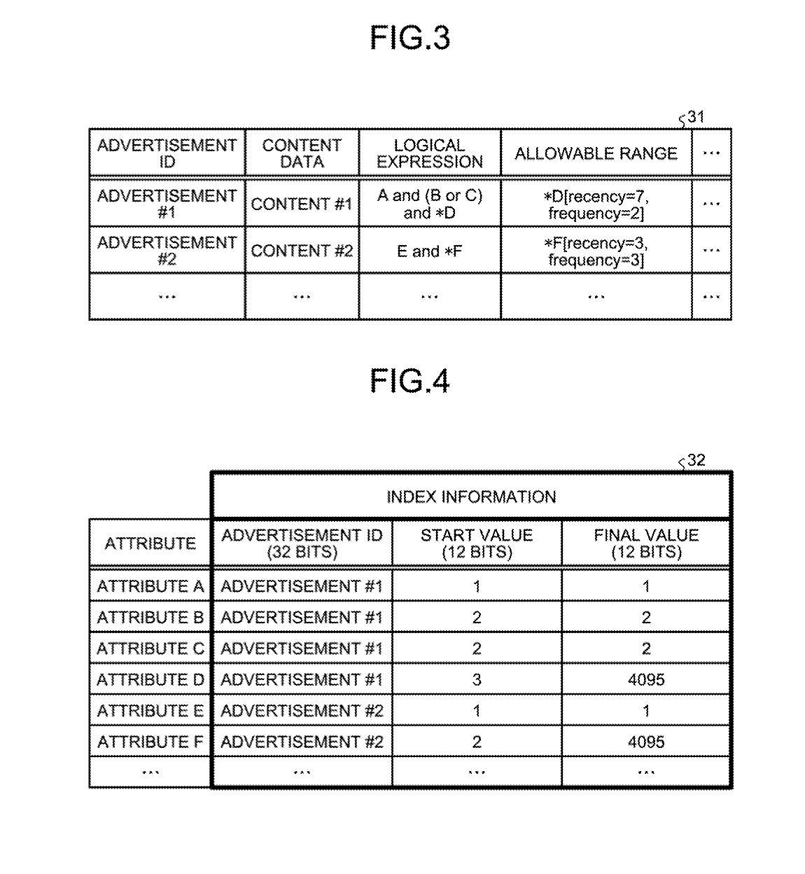

In the advertisement database 31, an advertisement that becomes the distribution target is registered. For example, FIG. 3 is a diagram illustrating an example of information registered in the advertisement database according to the embodiment. In the example illustrated in FIG. 3, in the advertisement database 31, the information, such as “advertisement ID”, “content data”, “logical expression”, and “allowable range information”, and the like, is registered. Furthermore, in the advertisement database 31, in addition to the information illustrated in FIG. 3, for example, arbitrary information, such as the click-through rate (CTR), cost per mule (CPM), or the like, related to an advertisement may also be registered.

Here, the “advertisement ID” is an identifier for identifying an advertisement. The “content data” is data on the content, which is displayed as the advertisement, such as an image, a text, or the like of the advertisement indicated by the associated “advertisement ID”. Furthermore, the “logical expression” is the logical expression indicating the attribute of the user corresponding to the distribution destination of the advertisement indicated by the associated, “advertisement ID”, i.e., the logical expression indicating the condition of the attribute of the distribution destination. Furthermore, the “allowable range information” is the allowable range information that is set in the condition included in the associated logical expression.

For example, in the example illustrated in FIG. 3, in the advertisement database 31, the advertisement ID “advertisement #1”, the content data “content #1”, the logical expression “A and (B or C) and *D”, and the allowable range information “*D[recency=7, frequency=2]” are registered. These pieces of information indicates that the data on the content displayed as the advertisement indicated by the advertisement ID “advertisement #1” is the content data “content #1”; indicates that the distribution destination of the attribute indicated by the logical expression “A and (B or C) and *D” is the target; and. indicates that the allowable range indicated by the allowable range information “*D[recency=7, frequency=2]” is set in the condition D.

In the example illustrated in FIG. 3, conceptual values, such as the “advertisement #1”, the “content #1”, or the like, are represented; however, in practice, in the advertisement database 31, a numerical value or a character string that identifies the advertisement or the data on the characters, images, or the like, constituting the content is registered.

A description will be continued by referring back so FIG. 2. The index of each of the advertisements is registered in the index database 32. For example, FIG. 4 is a diagram illustrating an example of information registered in the index database according to the embodiment In the example illustrated in FIG. 4, items, such as “attribute”, “advertisement ID (32 bits)”, “start value (12 bits)”, and “final value (12 bits)” are registered in the index database 32. Furthermore, the number of bits described in the parentheses in each of the items is the information indicating the data length of each of the items and the descriptions thereof will be omitted in a description below.

Here the “attribute” is a condition included in the logical expression of each of the items and is the information indicating the attribute of the user corresponding to the distribution destination of the advertisement. Furthermore, the “start value” is a start value of continuous values. Furthermore, the “final value” is a final value of the continuous values. For example, in the exam illustrated in FIG. 4, the attribute “attribute A”, the advertisement ID “advertisement #1”, the start value “1”, and the final value “1” are registered in an associated manner. This information indicates that, the advertisement indicated by the advertisement ID “advertisement #1”, the start value “1” of the continuous values and the final value “1” of the continuous values are set in the attribute “attribute A” (i.e., the condition “A”). Furthermore, it is assumed that, from among the pieces of the information illustrated in FIG. 4, the “attribute” is the information different from the index main body and the information constituted from the “advertisement ID”, the “start value”, and the “final value” are included in the index. Furthermore, the data structure of the index database 32 is not limited to the structure illustrated in FIG. 4. For example, the index database 32 may also include a different page for each condition that can be set and the index associated with each page may also be registered.

A description will be continued by referring back to FIG. 2. The control unit 40 is a controller and is implemented by, for example, a processor, such as a central processing unit (CPU), a micro processing unit (MPU), or the like, executing various kinds of programs, which are stored in a storage device in the information distribution device 10, by using a RAM or the like as a work area. Furthermore, the control unit 40 is a controller and may also be implemented by, for example, an integrated circuit, such as an application specific integrated circuit (ASIC), a field programmable gate array (FPGA), or the like. Furthermore, the control unit 40 corresponds to an arithmetic processing device that reads the index.

As illustrated in FIG. 2, the control unit 40 includes a registration receiving unit 41, an index creating unit 42, a request receiving unit 43, a first determination unit 44, a second determination unit 45, a decision unit 46, and a distributing unit 47. The registration receiving unit 41 receives registration of an advertisement. For example, the registration receiving unit 41 receives, from the distribution source server 300, registration of the content data of the advertisement that becomes the distribution target, the logical expression that includes the condition of the distribution destination, and the allowable range information. In such a case, the registration receiving unit 41 creates an advertisement ID and provides the advertisement ID and the various kinds of received data to the index creating unit 42.

The index creating unit 42 creates the index of the advertisement. For example, the index creating unit 42 allocates the continuous values to each of the conditions by analyzing the received logical expression, allocating the same range from among the continuous values of 1 to 4095 to a plurality of characteristics constituting the logical disjunction, and allocating the continuous values of 1 to 4095 to one or a plurality of characteristics constituting the logical conjunction. Furthermore, if a conditional expression corresponds to the logical disjunction of a plurality of logical conjunctions, the index creating unit 42 allocates the continuous values to the condition included in each of the logical conjunctions such that the value of the final value is not overlapped. Then, the index creating unit 42 creates, for each condition, the index in which the advertisement ID, the start value of the continuous values, and the final value of the continuous values are associated and then registers the created index in the index database 32. Furthermore, the index creating unit 42 registers the advertisement ID, the content data, the logical expression, and the allowable range information in the advertisement database 31.

The request receiving unit 43 receives an advertisement request from the user terminal 200. In such a case, the request receiving unit 43 sends the information on the user U01 who uses the user terminal 200 to the log server 100 and acquires the attribute information on the user U01. For example, the request receiving unit 43 sends the terminal identifier that identifies the user terminal 200 as the information indicating the user U01 and acquires the attribute information on the user U01. Then, the request receiving unit 43 provides the received attribute information to the first determination unit 44 as a query.

If the first determination unit 44 receives the query including the attribute information indicating the attribute of the distribution destination, the first determination unit 44 refers to the condition information in which a plurality of conditions that indicates an attribute of a distribution destination of the advertisement and that includes the condition in which the allowable range is set is represented by the Boolean operation expression and then determines whether the attribute information matches the plurality of conditions. More specifically, if the condition that indicates the attribute of the distribution destination and in which the allowable range related to the attribute is set is included in the condition information, the first determination unit 44 determines whether the attribute indicated by the condition matches the attribute indicated by the attribute information.

Furthermore, if the condition that indicates the action taken by the distribution destination and in which the allowable range related to the date and time of the action, the frequency of the action, or the number of times of actions is set is included in the condition information, the first determination unit 44 determines whether the action indicated by the condition matches the action indicated by the attribute information. As a specific example, if a search query that is input by the distribution destination and the condition in which the a Towable range related to the date and time, the frequency, or the number of times of inputs of the search query is set are included in the condition information, the first determination unit 44 determines whether the subject search query matches the search query indicated by the attribute information.

More specific example will be described. Furthermore, in a description below, it is assumed that the information illustrated in FIGS. 3 and 4 has been registered in each of the databases 31 and 32, respectively. For example, the information distribution device 10 receives the attribute “A”, the attribute “C”, and the attribute “D (recency=3, frequency=3)” as a query.

In such a case, for example, the first determination unit 44 refers to the final value of the index that includes the advertisement ID “advertisement #1” and selects the condition “A.” associated with the index having the smallest final value. At this point, because the attribute “A” is included in the query, the first determination unit 44 stores “1” in the element associated with the start value “1” and the final value “1” of the condition “A” in the determination matrix. Subsequently, the first determination unit 44 refers to the final value of the index that includes the advertisement ID “advertisement 1” and selects the condition “B” associated with the index having the smallest final value. At this point, because the attribute “B” is not included in the query, the first determination unit 44 refers to the final value of the index that includes the advertisement ID “advertisement #1” and selects the other condition “C” associated with the index having the smallest final value. At this point, because the attribute “C” is included in the query, the first determination unit 44 stores “1” in the element associated with the start value “2” and the final. value “2” of the condition “C” in the determination matrix.

Subsequently, the first determination unit 44 refers to the final value of the index including the advertisement ID “advertisement #1” and selects the condition “D” associated with the index having the smallest final value. Here, because the attribute “D” is included in the query, the first determination unit 44 stores “1” in the element associated with the start value “3” and the final value “4095” of condition “D” in the determination matrix. Consequently, because the value “1” is continuously stored from the top to the bottom of the determination matrix, the first determination unit 44 can determine that the attribute information satisfies the logical expression of the advertisement ID “advertisement #1”. By recursively performing this process, the first determination unit 44 determines whether the attribute information satisfies the condition information.

If it is determined that, from among the plurality of conditions, the attribute information matches the condition in which the allowable range is set, the second determination unit 45 determines whether the attribute information satisfies the allowable range that is set in the condition. More specifically, if the attribute included in the attribute information matches the attribute indicated by the condition, the second determination unit 45 determines whether the numerical value included in the attribute information satisfies the allowable range that is included in the condition. For example, if it is determined that the action indicated by the action information matches the action indicated by the condition, the second determination unit 45 determines whether the date and time, the frequency, or the number of times included in the combination of the action information satisfies the allowable range that is set in the condition.

For example, if it is determined by the first determination unit 44 that the condition “D” in which the allowable range is set matches the attribute “D” in the attribute information, the second determination unit 45 reads the allowable range information “*D[recency=7, frequency=2]” of the condition “D” from the advertisement database 31. Then, the second determination unit 45 determines whether the numerical value “(recency=3, frequency=3)” that is set in the attribute “D” satisfies the allowable range information “*D[recency=7, frequency=2]”. Then, if the value of “recency” in the attribute information is equal to or less than the value of “recency” included in the allowable range information and if the value of “frequency” in the attribute information equal to or greater than the value of “frequency” included in the allowable range information, the information distribution device 10 determines that the numerical value in the attribute information satisfies the allowable range information.

The decision unit 46 decides whether the advertisement is the distribution target based on the determination results obtained by the first determination unit 44 and the second determination unit 45. More specifically, if it is determined that, from among the conditions included in the condition information, the condition matched with the attribute information satisfies the Boolean operation expression and the attribute information satisfies all of the allowable ranges that are set in the conditions that satisfy the Boolean operation expression, the decision unit 46 decides that the advertisement associated with the condition information is the distribution target.

For example, from among the conditions included in the logical expression “A and (B or C) and *D”, if the condition “A”, the condition “C”, and the condition “C” match the attribute information, the decision unit 46 determines that the condition that matched with the attribute information satisfies the logical expression. Furthermore, if the attribute information satisfies all of the allowable ranges that are set in the condition “A”, the condition “C”, and the condition “D” that are the factors in satisfying the logical expression, i.e., the allowable range that is set in the condition “D”, the decision unit 46 determines that the attribute information satisfies the allowable range of the condition information. Consequently, the decision unit 46 determines that the associated advertisement, i.e., the advertisement indicated by the advertisement ID “advertisement #1”, is the distribution target.

The distributing unit 47 distributes the advertisements decided to be the distribution target to the user terminal 200. For example, the distributing unit 47 further selects, from the advertisements decided to be the distribution target, the advertisement that becomes the distribution target in accordance with a predetermined condition, such as a value of a previously set bid score, or the like, and distributes the selected advertisement.

4. Example of the Flow of the Process Performed by the Information Distribution Device

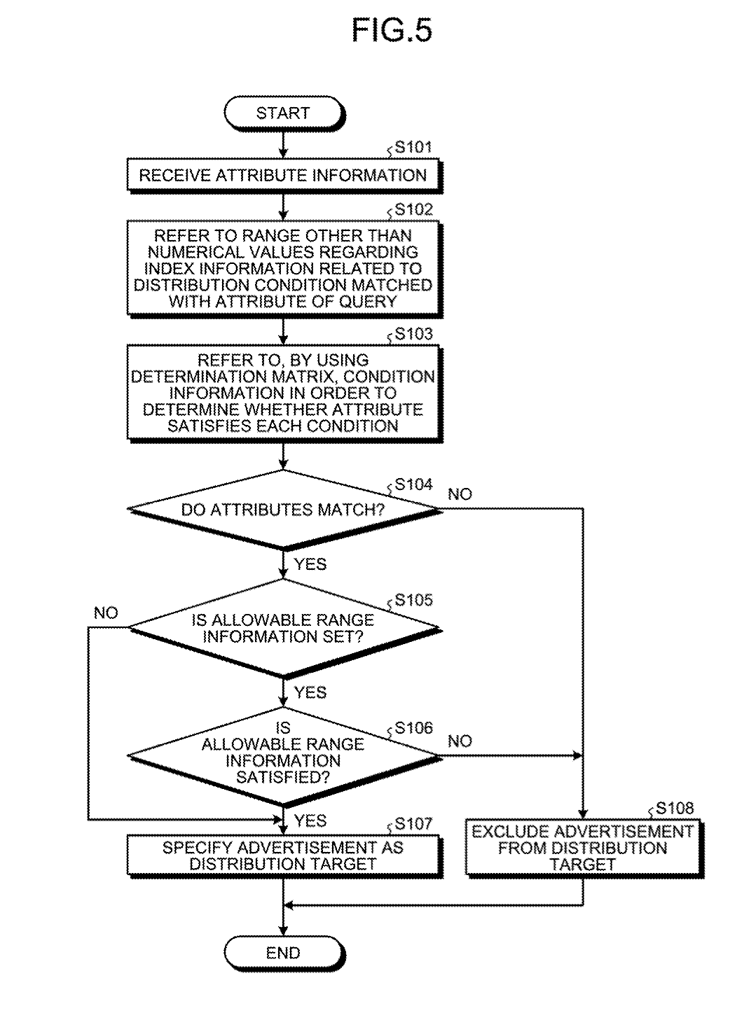

In the following, the flow of the decision process performed by the information distribution device 10 will be described with reference to FIG. 5. FIG. 5 is a flowchart illustrating an example of the flow of the decision process performed by the information distribution device according to the embodiment. The information distribution device 10 can perform the process in parallel illustrated in FIG. 5 for each advertisement.

For example, the information distribution device 10 receives, from the log server 100, the attribute information corresponding to a query (Step S101). In such a case, the information distribution device 10 refers to the range other than the numerical value in the condition information (Step S102) and refers to the condition information (Step S103). Then, the information distribution device 10 determines whether the attribute included in the attribute information matches the attribute indicated by the condition included in the condition information (Step S104) and determines, if it is determined that both match (Yes at Step S104), whether the allowable range information is set (Step S105). Furthermore, if the allowable range information is set (Yes at Step S105), the information distribution device 10 compares the allowable range information with the numerical value set in the attribute information and determines whether the numerical value set in the attribute information satisfies the allowable range information (Step S106).

Then, if the allowable range information is satisfied (Yes at Step S106), the information distribution device 10 determines that the advertisement is the distribution target (Step S10) and ends the process. In contrast, if the condition information does not match the attribute information (No at Step S104) or if the allowable range information is not satisfied (No at Step S106), the information distribution device 10 excludes the advertisement from the distribution target (Step S108) and ends the process. Furthermore, if the allowable range information is not set (No at Step S105), the information distribution device 10 performs the process at Step S107.

5. Modification

In the above description, an example of the decision process performed by the information distribution device 10 has been described. However, the embodiment is not limited to this. In the following, a variation in the decision process performed by the information distribution device 10 will be described.

5-1. Purpose of the Process

In the example described above, the information distribution device 10 distributes an advertisement as the distribution target. However, the embodiment is not limited to this. For example, the information distribution device 10 may also use arbitrary information, such as image content, voice content, moving image content, an electronic book, a news feed, a story of microblog, or the like, as the distribution target as long as the distribution target is changed in accordance with the attribute of the distribution destination. Furthermore, the information distribution device 10 may also distribute not only the content that is in accordance with the attribute of the distribution destination but also the content that matches, for example, the condition desired by the distribution destination.

Furthermore, the information distribution device 10 does not need to distribute content to the user U01 but may also distribute content to various servers. Namely, the decision process described above may also calculate a priority that is used when arbitrary content that matches the distribution target is selected based on the arbitrary condition with respect to the arbitrary distribution destination as long as the priority that is used when the content that becomes the distribution target is selected is calculated based on the condition in accordance with the distribution destination, such as the attribute, a desire, or the like, of the distribution destination.

5-2. About the Allowable Range

In the example described above, the information distribution device 10 uses the value of “recency” indicating the period of time of the date and time of the action taken or the value of “frequency” indicating the number of times or the frequency of the action taken as the numerical value of the attribute information or the allowable range information. However, the embodiment is not limited to this. Namely, the information distribution device 10 may also use not only these pieces of information but also an arbitrary value as the allowable range information as long as the value is a numerical value indicating the allowable range related to the attribute of the distribution destination.

For example, the information distribution device 10 stores the allowable range information “location [distance=500 meters from Tokyo station]” by associating the information with the condition “location” that uses the location of the distribution destination as the condition. Furthermore, if the attribute indicating the current location of the distribution destination is included in the attribute information on the distribution destination, the information distribution device 10 determines that the condition matches the attribute regardless of the subject location. Then, only when the condition matches the attribute, the information distribution device 10 determines whether the current location of the distribution destination is the location that satisfies the allowable range information “[distance=500 meters from Tokyo station]”, i.e., whether the current location is within 500 meters from Tokyo station. If the current location of the distribution destination is the location that satisfies the allowable range information “[distance=500 meters from Tokyo station]”, the information distribution device 10 may also determine that the condition information satisfies the allowable range information.

5-3. Configuration of the Device

The information distribution device 10 may also be connected to an arbitrary number of the user terminals 200 such that they can communicate each other. Furthermore, the information distribution device 10 may also be implemented by a front end server that sends and receives information to and from the user terminal 200 and the distribution source server 300 and a back end server that performs the decision process. In such a case, the registration receiving unit 41 and the distributing unit 47 illustrated in FIG. 2 are disposed in the front end server, whereas the back end server includes the index creating unit 42, the request receiving unit 43, the first determination unit 44, the second determination unit 45, and the decision unit 46. Furthermore, each of the databases 31 and 32 registered in the storage unit 30 may also be held by an external storage server.

5-4. Others

Of the processes described in the embodiment, the whole or a part of the processes that are mentioned as being automatically performed can also be manually performed, whereas the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, each of the embodiments described above can be appropriately used in combination as long as the processes do not conflict with each other.

5-5. Program

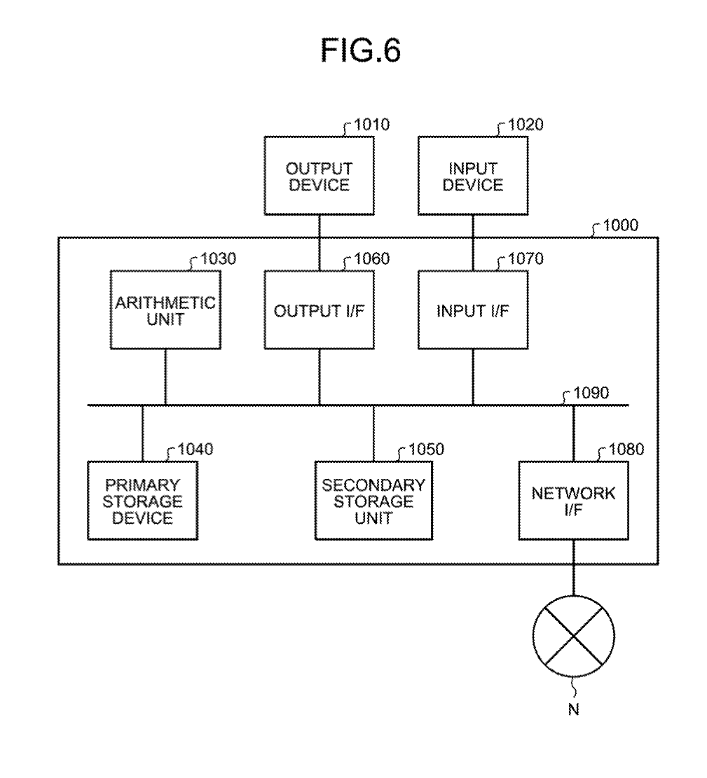

Furthermore, the information distribution device 10 according to the embodiment described above is implemented by a computer 1000 having the configuration illustrated in, for example, FIG. 6. FIG. 6 is a diagram illustrating an example of a hardware configuration. The computer 1000 is connected to an output device 1010 and an input device 1020 and has the configuration in which an arithmetic unit 1030, a primary storage device 1040, a secondary storage unit 1050, an output interface (I/F) 1060, an input I/F 1070, a network I/F 1080 are connected via a bus 1090.

The arithmetic unit 1030 is operated based on the programs stored in the primary storage device 1040 or the secondary storage unit 1050 or based on the programs read from the input device 1020 and performs various kinds of processes. The primary storage device 1040 is a memory device, such as a RAM, or the like, that primarily stores therein data that is used by the arithmetic unit 1030 to perform various kinds of arithmetic operations. Furthermore, the secondary storage unit 1050 is a storage device in which data that is used by the arithmetic unit 1030 to perform various kinds arithmetic operations and various kinds of databases are registered and is implemented by a read only memory (ROM), an HDD, a flash memory, and the like.

The output I/F 1060 is an interface for sending information that is targeted for an output with respect to the output device 1010, such as a monitor, a printer, or the like, that outputs various kinds of information and is implemented by, for example, the standard connector, such as a universal serial bus (USB), a digital visual interface (DVT), a High Definition Multimedia Interface (registered trademark) (HDMI), or the like. Furthermore, the input I/F 1070 is an interface for receiving information from various kinds of the input device 1020, such as a mouse, a keyboard, a scanner, or the like, and is implemented by, for example, an USE, or the like

Furthermore, the input device 1020 may also be, for example, an optical recording medium, such as a compact disc (CD), a digital versatile disc (DVD), a phase change rewritable disk (PD), or the like; a magneto-optical recording medium, such as a magneto-optical disk (MO), or the like; or a device that reads information from a tape medium, a magnetic recording medium, a semiconductor memory, or the like. Furthermore, the input device 1020 may also be an external storage medium, such as a USE memory, or the like.

The network I/F 1080 receives data from another device via the network N and sends the data to the arithmetic unit 1030. Furthermore, the network I/F 1080 sends the data created by the arithmetic unit 1030 to the other device via the network N.

The arithmetic unit 1030 controls the output device 1010 or the input device 1020 via the output I/F 1060 or the input I/F 1070, respectively. For example, the arithmetic unit 1030 loads the program from the input device 1020 or the secondary storage unit 1050 into the primary storage device 1040 and executes the loaded program.

For example, if the computer 1000 functions as the information distribution device 10, the arithmetic unit 1030 in the computer 1000 implements the function of the control unit 40 by executing the program loaded in the primary storage device 1040.

6. Effects

As described above, if the information distribution device 10 receives a query including the attribute information indicating the attribute of the distribution destination, the information distribution device 10 refers to condition information, in which a plurality of conditions that indicates an attribute of a distribution destination of predetermined information and that includes a condition in which an allowable range is set is represented by a Boolean operation expression, and determines whether the attribute information matches the plurality of the conditions. Then, if it is determined that, from among the plurality of the conditions, the attribute information matches the condition in which the allowable range is set, the information distribution device 10 determines whether the attribute information satisfies the allowable range that is set in the condition. Then, the information distribution device 10 decides, based on each determination result, whether predetermined information is the distribution target. Consequent because the information distribution device 10 can determine whether the condition information matches the attribute information without developing a plurality of pieces of the condition information that satisfies the allowable range, thereby promptly extracting an advertisement that becomes the distribution target.

Furthermore, if it is determined that the condition that is matched with the attribute information from among the conditions included in the condition information satisfies the logical expression that is the Boolean operation expression and if it is determined that the attribute information satisfies all of the allowable ranges that are set with respect to the conditions, from among the conditions, that satisfy the Boolean operation expression, the information distribution device 10 decides that the predetermined information is the distribution target. Consequently, even if one or a plurality of allowable ranges is set, the information distribution device 10 can promptly extract an advertisement that becomes the distribution target.

Furthermore, if the condition that indicates the attribute of the distribution destination and in which the allowable range related to the attribute is set is included the condition information, the information distribution device 10 determines whether the attribute indicated the subject condition matches attribute indicated by the at information. Then, it the attribute indicated the condition matches the attribute indicated by the attribute information, the information distribution device 10 determines whether range of the attribute indicated the attribute information satisfies the allowable range that is set in the condition. Consequent information distribution device 10 can promptly determine whether the distribution destination satisfies the attribute that is indicated by the condition and in which the allowable range is set.

Furthermore, if the condition that indicates the action taken by the distribution destination and in which the allowable range related to the date and time, the frequency, or the number of times of the action is set is included in the condition information, the information distribution device 10 determines whether the action indicated by the condition matches the attribute information. Then, if the action indicated by the condition matches the action indicated by the attribute information, the information distribution device 10 determines whether the date and time, the frequency, or the number of times of the action that is taken and indicated by the attribute information satisfies the allowable range that is set in the condition. Consequently, the information distribution device 10 can promptly determine whether the distribution destination has taken the action that is indicated by the condition and in which the date and time, the frequency, or the number of times is set.

Furthermore, if a search query that is input by the distribution destination and the condition in which the allowable range that is related to the date and time, the frequency, or the number of times of the inputs of the search query is set are included in the condition information, the information distribution device 10 determines whether the subject search query matches the search query that is input by the distribution destination indicated by the attribute information. Then, if the search query indicated by the condition matches the search query indicated by the attribute information, the information distribution device 10 determines whether the date and time, the frequency, or the number of times of the inputs of the search query indicated by the attribute information satisfies the allowable range that is set in the condition. Consequently, the information distribution device 10 can promptly determine whether the distribution destination has input a predetermined search query on the predetermined date and time, the predetermined frequency, or the predetermined number of times.

Furthermore, if both the condition indicating that the location of the distribution destination is used and the allowable range information indicating the allowable range of the location are included in the condition information, the information distribution device 10 determines whether the information indicating the location of the distribution destination is included in the attribute information. Then, if it is determined that the information indicating the location of the distribution destination is included in the attribute information, the information distribution device 10 determines whether the location of the distribution destination is included in the range indicated by the allowable range information. Consequently, the information distribution device 10 can promptly determine whether the distribution destination Is within a predetermined range.

Furthermore, the “components (sections, modules, units)” described above can be read as “means”, “circuits”, or the like. For example, the distributing unit can be read as a distribution means or a distribution circuit.

According to an aspect of an embodiment, it is possible to reduce the time taken to extract information that becomes the distribution target.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A decision device comprising:
a first determination unit that refers to, when a query that includes attribute information indicating an attribute of a distribution destination is received, condition information, in which a plurality of conditions that indicates an attribute of a distribution destination of predetermined information and that includes a condition in which an allowable range is set is represented by a Boolean operation expression, and that determines whether the attribute information matches the plurality of the conditions;
a second determination unit that determines, when it is determined that, from among the plurality of the conditions, the attribute information matches the condition in which the allowable range is set, whether the attribute information satisfies the allowable range that is set in the condition; and
a decision unit that decides, based on determination results obtained by the first determination unit and the second determination unit, whether the predetermined information is a distribution target.

2. The decision device according to claim 1, wherein, when it is determined that the condition matched with the attribute information from among the conditions included in the condition information satisfies the Boolean operation expression and it is determined that the attribute information satisfies all of the allowable ranges that are set in the conditions that satisfy the Boolean operation expression from among the conditions, the decision unit decides that the predetermined information is the distribution target.

3. The decision device according to claim 1, wherein
when the condition that indicates the attribute of the distribution destination and in which the allowable range related to the attribute is set is included in the condition information, the first determination unit determines whether the attribute indicated by the condition matches the attribute indicated by the attribute information, and
when the attribute indicated by the condition matches the attribute indicated by the attribute information, the second determination unit determines whether the range of the attribute indicated by the attribute information satisfies the allowable range that is set in the condition.

4. The decision device according to claim 1, wherein
when the condition that indicates an action taken by the distribution destination and in which the allowable range related to the date and time, a frequency, or the number or times of the action taken is set is included in the condition information, the first determination unit determines whether the action indicated by the condition matches the action indicated by the attribute information, and
when the action indicated by the condition matches the action indicated by the attribute information, the second determination unit determines whether the date and time, the frequency, or the number of times of the action that is taken and indicated by the attribute information satisfies the allowable range that is set in the condition.

5. The decision device according to claim 1, wherein
when a search query that is input by the distribution destination and the condition in which the allowable range related to the date and time, the frequency, or the number of times of inputs of the search (query is set are included in the condition information, the first determination unit determines whether the search query matches the search query that is input by the distribution destination indicated by the attribute information, and
when the search query indicated by the condition matches the search query that is input by the distribution destination indicated by the attribute information, the second determination unit determines whether the date and time, the frequency, or the number of times of the inputs of the search query indicated by the attribute information satisfies the allowable range that is set in the condition.

6. The decision device according to claim 1, wherein
when the condition indicating that the location of the distribution destination is used and allowable range information indicating the allowable range of the location are included in the condition information, the first determination unit determines whether the information indicating the location of the distribution destination is included in the attribute information, and
when it is determined that the information indicating that the location of the distribution destination is included in the attribute information, the second determination unit determines whether the location of the distribution destination is included in the range indicated by the allowable range information.

7. A decision method performed by a decision device, the decision method comprising:
referring to, when a query that includes attribute information indicating an attribute of a distribution destination is received, condition information, in which a plurality of conditions that indicates an attribute of a distribution destination of predetermined information and that includes a condition in which an allowable range is set is represented by a Boolean operation expression;
determining whether the attribute information matches the plurality of the conditions;
determining, when it is determined that, from among the plurality of the conditions, the attribute information matches the condition in which the allowable range is set, whether the attribute information satisfies the allowable range that is set in the condition; and
deciding, based on determination results obtained at the first determination step and the second determination step, whether the predetermined information is a distribution target.

8. A non-transitory computer-readable recording medium having stored a decision program that causes a computer to execute a process comprising:
referring to, when a query that includes attribute information indicating an attribute of a distribution destination is received, condition information, in which a plurality of conditions that indicates an attribute of a distribution destination of predetermined information and that includes a condition in which an allowable range is set is represented by a Boolean operation expression;
determining whether the attribute information matches the plurality of the conditions;
determining, when it is determined that, from among the plurality of the conditions, the attribute information matches the condition in which the allowable range is set, whether the attribute information satisfies the allowable range that is set in the condition; and
deciding, based on determination results obtained at the first determination step and the second determination step, whether the predetermined information is a distribution target.
